(19) United States
(12) Patent Application Publication
(10) Pub. No.: US 2007/0185873 A1
(43) Pub. Date: Aug. 9, 2007

(54) Processing disparate artifact attributes for a shared artifact in a collaborative environment

(75) Inventors: Michael Muller, Medford, MA (US); Andrew L. Schirmer, Andover, MA (US); Paul B. Moody, Hyde Park, VT (US); Martin T. Moore, Somerville, MA (US)

Correspondence Address: Steven M. Greenberg, Esquire;Christopher & Weisberg, P.A., 200 East Las Olas Boulevard, Suite 2040, Fort Lauderdale, FL, 33301, US

(73) Assignee: International Business Machines Corporation, Armonk, NY (US)

(21) Appl. No.: 11/336,180

(22) Filed: Jan. 20, 2006

(51) Int. Cl. G06F 17/30

(52) U.S. Cl. 707/9

(57) ABSTRACT

Embodiments of the present invention address deficiencies of the art in respect to assigning attributes to shared artifacts in a collaborative environment and provide a method, system and computer program product for end-user based processing of different attributes for a common shared artifact in a collaborative environment. In one embodiment, a data processing system configured for end-user based processing of different attributes for a commonly shared artifact in a collaborative environment can include a collaborative environment, one or more shared artifacts disposed within the collaborative environment, and artifact processing logic. The artifact processing logic can include program code enabled to assign different attributes corresponding to different end users to a commonly shared one of the shared artifacts.

### BACKGROUND OF THE INVENTION

1. Field of the Invention

The present invention relates to collaborative computing and more particularly to the assignment of attributes to a shared artifact in a collaborative environment.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

Collaborative computing environments rely upon the sharing of artifacts among end user participants to the collaborative environment. In this regard, artifacts within the collaborative environment can include shared documents, tasks, activities, views, and communicative sessions among collaborators such as chats and instant messaging sessions. Generally, a collaborative computing environment can provide a unified view of shared artifacts organized in a meaningful way. Examples include a hierarchical view of tasks to be completed as part of one or more activities in a collaborative project. Other examples include a listing of documents shared among collaborators in a collaborative effort.

Within a conventional collaborative computing environment, each shared artifact enjoys attributes assigned to it for the benefit of end-users sharing access to the artifact. Specifically, a unified set of attributes can be applied to a shared artifact for all accessing the shared artifact. The unified set of attributes can range from the simple assignment of a name to the shared artifact, to the complex association of resources with the shared artifact.

Yet, assigning a unified set of attributes to a shared artifact without respect to the identity of an end-user can inhibit the personalization of the collaborative experience for end users whose view of a collaborative project can differ from one end user to the next. Furthermore, oftentimes, attributes are assigned an informal manner by an end user. As such, little consideration is paid to the attributes as they relate to the different collaborative perspectives of other end users in the collaborative environment.

### BRIEF SUMMARY OF THE INVENTION

Embodiments of the present invention address deficiencies of the art in respect to assigning attributes to shared artifacts in a collaborative environment and provide a novel and non-obvious method, system and computer program product for end-user based processing of different attributes for a common shared artifact in a collaborative environment. In one embodiment, a data processing system configured for end-user based processing of different attributes for a commonly shared artifact in a collaborative environment can include a collaborative environment, one or more shared artifacts disposed within the collaborative environment, and artifact processing logic. The artifact processing logic can include program code enabled to assign different attributes corresponding to different end users to a commonly shared one of the shared artifacts.

In another embodiment of the invention, a method for end-user based processing of different attributes for a commonly shared artifact in a collaborative environment can include assigning different attributes to a commonly shared artifact in a collaborative environment, each of the different attributes corresponding to a different end user. The method further can include rendering a view of the commonly shared artifact for each different end user utilizing an assigned different attribute corresponding to the different end user. For example, assigning different attributes to a commonly shared artifact in a collaborative environment can include assigning a different nickname to a commonly shared artifact in a collaborative environment, each different nickname corresponding to a different end user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial montage of a collaborative environment configured for end-user based processing of different attributes for a commonly shared artifact;

FIG. 2 is a schematic illustration of a data processing system configured for end-user based processing of different attributes for a commonly shared artifact in a collaborative environment; and,

FIG. 3 is a flow chart illustrating a process for end-user based processing of different attributes for a commonly shared artifact in a collaborative environment.

### DETAILED DESCRIPTION OF THE INVENTION

Embodiments of the present invention provide a method, system and computer program product for end-user based processing of different attributes for a commonly shared artifact in a collaborative environment. In accordance with an embodiment of the present invention, shared artifacts within a collaborative environment each can be assigned different attributes selected based upon the identity of an end user accessing the shared artifact. In this regard, the attributes can range from the name of the shared artifact to the type of shared artifact. As such, the name of a shared artifact in a collaborative environment can vary from end user to end user, as can the type of shared artifact.

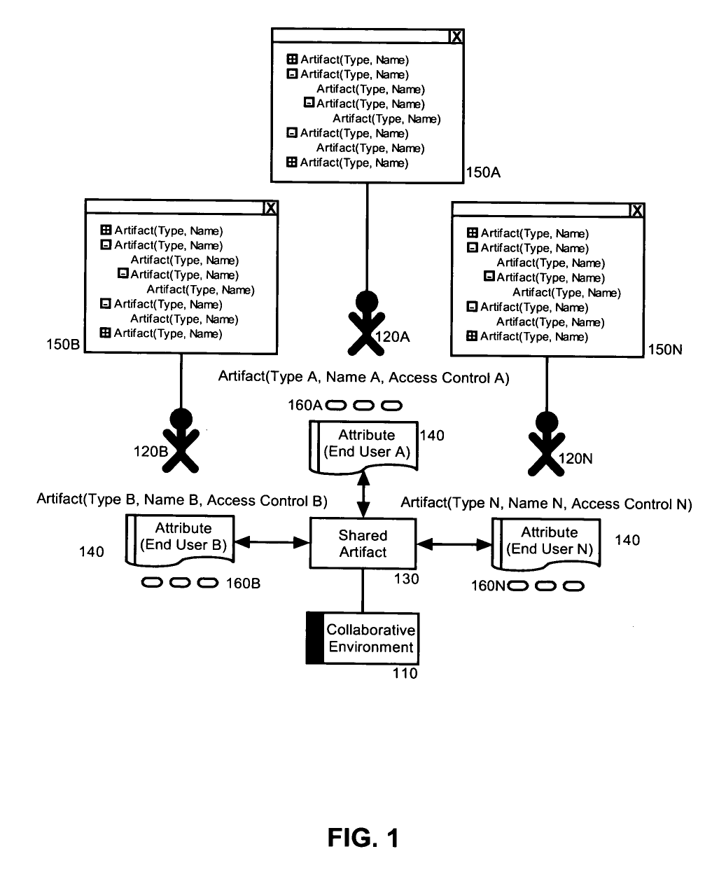

In further illustration, FIG. 1 is a pictorial montage of a collaborative environment configured for end-user based processing of different attributes for a commonly shared artifact. Referring to FIG. 1, multiple end users 120A, 120B, 120N can interact with a collaborative environment 110 through respective views 150A, 150B, 150N. Each of the views 150A, 150B, 150N can incorporate a rendering of one or more shared artifacts 130 (only a single shared artifact 130 is shown for the purpose of illustrative simplicity). In this regard, a shared artifact 130 is a collaborative object established for use by the end users 120A, 120B, 120N in collaborating within the collaborative environment 110. By way of example, a shared artifact 130 can include a message such as an e-mail, a task, an activity, or a resource such as a document, to name only a few.

In operation, attributes 140A, 140B, 140N can be assigned to a commonly shared artifact 130. Attributes 140A, 140B, 140N can include, for instance, a name for the shared artifact 130. The attributes 140A, 140B, 140N further can include a type for the shared artifact 130, such as a message, task or resource. The attributes 140A, 140B, 140N yet further can include public and private resources associated with the shared artifact 130 such as associated documents and messages. The attributes 140A, 140B, 140N even yet further can include status information for the shared artifact 130 such as the personal progress of a shared artifact for an end user, and also personal prioritizations and personal reporting and archiving requirements assigned to the shared artifact 130 for an end user. Finally, the attributes 140A, 140B, 140N can include personal concrete representations of the shared artifact 130, such as data produced in response to the shared artifact 130.

Once assigned, each different attribute 140A, 140B, 140N can be rendered within a corresponding view 150A, 150B, 150N for an associated end user 120A, 120B, 120N. In this way, the shared artifact 130 can be visually represented for each end user 120A, 120B, 120N in a personal, meaningful way, irrespective of the requirements of others of the end users 120A, 120B, 120N. Additionally, one or more decorators 160A, 160B, 160N can be rendered along with each of the attributes 140A, 140B, 140N for the shared artifact 130 in order to indicate the selected attributes 140A, 140B, 140N and also to indicate that the selected ones of the attributes 140A, 140B, 140N are personal to the respective end users 120A, 120B, 120N.

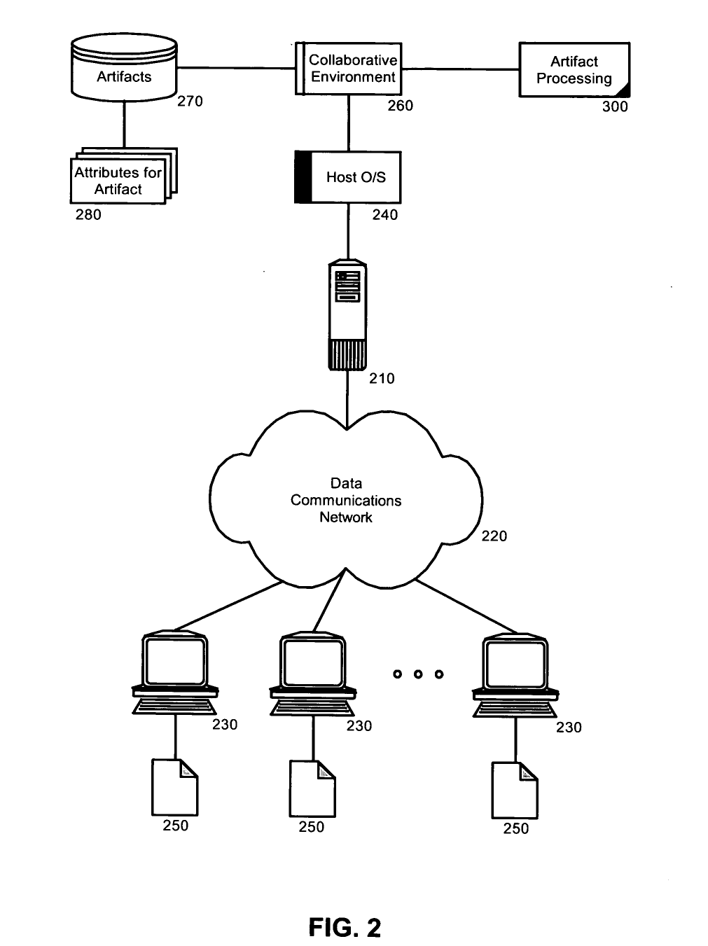

In a preferred embodiment of the invention, a data processing system can be configured for end-user based processing of different attributes for a common shared artifact in a collaborative environment, as shown in FIG. 2. Referring to FIG. 2, the data processing system can include a collaborative environment 260 hosted by an operating system 240 in a server computing arrangement of one or more server computing devices 210 (only a single server computing device shown for the purpose of illustrative simplicity). The collaborative environment 260 can be arranged to accommodate collaborative interactions by one or more end users through one or more end user computing devices 230 over a data communications network 220.

Importantly, the collaborative environment 260 can be coupled to a data store of artifacts 270 storing different commonly shared artifacts utilized within different views 250 by different end users accessing the collaborative environment. Artifact processing logic 300 can be coupled to the collaborative environment 260 and can include program code enabled to assign different attributes for a commonly shared artifact for different end users. To that end, a table of attributes 280 can be maintained for each commonly shared artifact such that the program code of the artifact processing logic 300 can resolve the identity of a referenced shared artifact and can provide a proper rendering and treatment of the shared artifact within each different view 250 for the end users.

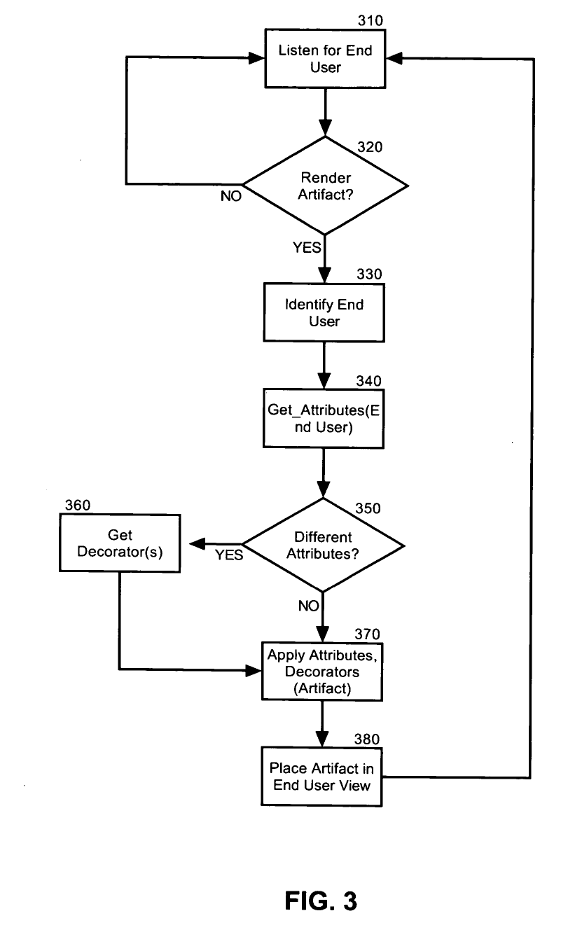

In even yet further illustration of the operation of the program code of the artifact processing logic 300, FIG. 3 is a flow chart illustrating a process for end-user based processing of different attributes for a common shared artifact in a collaborative environment. Beginning in block 310, end user activity can be observed to indicate whether a view is to be rendered to a collaborative space within the collaborative environment. In decision block 320, if end user activity is observed requiring the rendering of a view incorporating a shared artifact, in block 330, the end user can be identified and the process can continue in block 340.

In block 340, a set of one or more attributes which are personal to the identified end user can be retrieved for the shared artifact. The attributes can range from a nickname for the shared artifact to a type for the shared artifact. In decision block 350, if different attributes are to be applied to the shared artifact, in block 360, one or more decorators can be retrieved for the shared artifact. Regardless, in block 370, the attributes and decorators can be applied to the shared artifact and in block 380, the artifact can be placed within a view for the end user. In this way, the view of the shared artifact can be personalized in a meaningful way for the end user without subjecting all end users to the personalization reflected by the selected attributes.

As an example of the principle of the invention, a “nickname” for a common activity can be applied by each of several different end users to personalize the labeling of the common activity. End users who have chosen not to assign a nickname for the common activity view the originally assigned name of the activity. Once a nickname has been applied by an end user, a decorator icon can be rendered along with the activity in a view for the end user to indicate that a nickname has been assigned to the activity in lieu of the originally assigned name for the activity. Furthermore, nicknames can be shared among end users. Conversely, nicknames can be configured as private to the end user to prevent other end users from viewing the nickname for the activity.

As another example, individual end users can associate other artifacts with a shared artifact on a personal level. Specifically, the associated artifacts can be made invisible to other end users, or the associated artifacts can be made visible only for selected ones of the other end users. As yet another example, different status information and different tracking information can be applied to a shared artifact and, as in other examples, the status information can be selectively rendered public or private in relation to other end users. Optionally, the status information can include different values for the status attribute for different end users.

Notably, whereas the foregoing examples presume the manual assignment of attributes for a shared artifact by individual ones of the end users, in an aspect of the embodiment, a template can be defined for establishing different attributes to a shared artifact. The template can be stored within a library of templates. Subsequently, the template can be reused by other end users when assigning different attributes for a commonly shared artifact.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A data processing system configured for end-user based processing of different attributes for a commonly shared artifact in a collaborative environment, the data processing system comprising:
a collaborative environment;
a plurality of shared artifacts disposed within the collaborative environment; and,
artifact processing logic comprising program code enabled to assign different attributes corresponding to different end users to a commonly shared one of the shared artifacts.

2. The data processing system of claim 1, further comprising a table correlating the different attributes assigned to the commonly shared one of the shared artifacts.

3. The data processing system of claim 1, wherein the shared artifacts comprise artifacts selected from the group consisting of a task, an activity, a message, and a collaborative resource.

4. The data processing system of claim 1, wherein the different attributes comprise attributes selected from the group consisting of a nickname for the shared artifact, a type of the shared artifact, a resource associated with the shared artifact, status information for the shared artifact, a personal prioritization for the shared artifact, personal reporting and archiving requirements for the shared artifact, and a personal concrete representation of the shared artifact.

5. The data processing system of claim 4, wherein the type of the shared artifact comprises one of a task, resource, application, message or activity.

6. The data processing system of claim 4, wherein the attributes are assigned a designation selected from the group consisting of a public designation and a private designation.

7. A method for end-user based processing of different attributes for a commonly shared artifact in a collaborative environment, the method comprising:
assigning different attributes to a commonly shared artifact in a collaborative environment, each of the different attributes corresponding to a different end user; and,
rendering a view of the commonly shared artifact for each different end user utilizing an assigned different attribute corresponding to the different end user.

8. The method of claim 7, wherein assigning different attributes to a commonly shared artifact in a collaborative environment, comprises assigning a different nickname to a commonly shared artifact in a collaborative envirornent, each different nickname corresponding to a different end user.

9. The method of claim 7, wherein assigning different attributes to a commonly shared artifact in a collaborative environment, comprises assigning to the commonly shared artifact different attributes selected from the group consisting of a type of the shared artifact, a resource associated with the shared artifact, status information for the shared artifact, a personal prioritization for the shared artifact, personal reporting and archiving requirements for the shared artifact, and a personal concrete representation of the shared artifact.

10. The method of claim 7, wherein assigning different attributes to a commonly shared artifact in a collaborative environment, comprises:
loading a template of attributes; and,
assigning the attributes of the template to the shared artifact.

11. The method of claim 7, further comprising rendering selected ones of the different attributes as publicly viewable by other end users in the collaborative environment.

12. The method of claim 7, further comprising preventing selected ones of the different attributes from being viewed by other end users in the collaborative environment.

13. A computer program product comprising a computer usable medium having computer usable program code for end-user based processing of different attributes for a commonly shared artifact in a collaborative environment, said computer program product including:
computer usable program code for assigning different attributes to a commonly shared artifact in a collaborative environment, each of the different attributes corresponding to a different end user; and,
computer usable program code for rendering a view of the commonly shared artifact for each different end user utilizing an assigned different attribute corresponding to the different end user.

14. The computer program product of claim 13, wherein the computer usable program code for assigning different attributes to a commonly shared artifact in a collaborative environment, comprises computer usable program code for assigning a different nickname to a commonly shared artifact in a collaborative environment, each different nickname corresponding to a different end user.

15. The computer program product of claim 13, wherein the computer usable program code for assigning different attributes to a commonly shared artifact in a collaborative environment, comprises computer usable program code for assigning to the commonly shared artifact different attributes selected from the group consisting of a type of the shared artifact, a resource associated with the shared artifact, status information for the shared artifact, a personal prioritization for the shared artifact, personal reporting and archiving requirements for the shared artifact, and a personal concrete representation of the shared artifact.

16. The computer program product of claim 13, wherein the computer usable program code for assigning different attributes to a commonly shared artifact in a collaborative environment, comprises:
computer usable program code for loading a template of attributes; and,
computer usable program code for assigning the attributes of the template to the shared artifact.

17. The computer program product of claim 13, further comprising computer usable program code for rendering selected ones of the different attributes as publicly viewable by other end users in the collaborative environment.

18. The computer program product of claim 13, further comprising computer usable program code for preventing selected ones of the different attributes from being viewed by other end users in the collaborative environment.
